(19) United States
(12) Patent Application Publication
(10) Pub. No.: US 2008/0048044 A1
(43) Pub. Date: Feb. 28, 2008

(54) Barcode Encoding and Decoding

(75) Inventors: Xiaoxuan Zhao, Shanghai (CN); Yumin Shen, Shanghai (CN); George C. Yan, Shanghai (CN); Michael Aday, Bellevue, WA (US); Binyi Liu, Shanghai (CN); Jiana Liu, Shanghai (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/467,434

(22) Filed: Aug. 25, 2006

(51) Int. Cl. G06K 19/06

(52) U.S. Cl. 235/494

(57) ABSTRACT

Techniques to encode and decode barcodes are described. In an implementation, characters included in content are divided into a plurality of blocks, such that each block is to include compressed or non-compressed characters. An indication is added to a header for each block that specifies whether the block includes compressed or non-compressed characters. Blocks which include non-compressed characters are encoded with a particular codepage. The indication of the non-compressed characters in the header does not reference the particular codepage.

### BACKGROUND

Users are still continually exposed to a wide variety of products and printed content, such as magazines, newspapers, books, and so on. For instance, a user may read a morning newspaper, flip through a magazine, be handed a pamphlet, examine an instruction booklet, and so on. In order to expand the information that is available to these users as well as to manage the products themselves, techniques have been developed to provide machine-readable data along with the printed content to help the users locate additional information relating to the products and printed content.

One such technique involves the use of barcodes. A typical barcode, for instance, is configured as a single row of bars having differing thicknesses that are readable along a single axis and therefore are also referred to as “one-dimensional” barcodes. Once read, the row of bars may be decoded in order to arrive at text that is represented by the bars. This text may be used for a variety of purposes. For instance, a grocery store may scan a barcode of a product in order to obtain an identifier that represents the product. Using this identifier, the grocery store may then obtain a price for the product by querying a database having identifier/price combinations. One-dimensional barcodes, however, provided limited data due to the number of lines and spaces used by the barcode in representing the numbers.

Two-dimensional barcodes were developed to increase an amount of data that may be encoded by the barcode. For example, a two-dimensional barcode is readable along multiple axes (e.g., which may be configured as multiple parallel rows, vectors in different respective directions, and so on), each of which may be used to encode different data. Therefore, the amount of data that may be represented by the two-dimensional barcode may be increased in relation to one-dimensional barcodes. However, the two-dimensional barcode may consume a significant amount of space when included on a surface (e.g., a magazine) and therefore intrude on the “look and feel” of a product that includes the barcode. Additionally, traditional techniques that were used to encode and decode barcodes (both one and two dimensional barcodes) may be inefficient and therefore may result in a needless consumption of an area on a display surface that includes the barcode, such as through inclusion of redundant information.

### SUMMARY

Techniques to encode and decode barcodes are described. In an implementation, characters included in content are divided into a plurality of blocks, such that each block is to include compressed or non-compressed characters. An indication is added to a header for each block that specifies whether the block includes compressed or non-compressed characters. Blocks which include non-compressed characters are encoded with a particular codepage. The indication of the non-compressed characters in the header does not reference the particular codepage.

For example, the indication may be used to indicate that the non-compressed characters were encoded using a codepage and the compressed characters are encoded using a binary mapping scheme representation (e.g., eight bits) of the characters. Blocks that are encoded in eight-bits may then be decoded using a codepage while the compressed characters may be decoded directly from the binary mapping scheme representation. Thus, in this implementation the headers are not used to indicate a particular codepage and therefore do not provide redundant information. A variety of other implementations are also contemplated, such as use of color in a barcode, encoding of non-character binary data, such as audio and video content, and so on.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ barcode encoding and decoding techniques.

FIG. 2 is a flow diagram depicting a procedure in an exemplary implementation showing a simplified text encoding technique.

FIG. 3 is an illustration of encoding of content having compressed and non-compressed characters according to the procedure of FIG. 2.

FIG. 4 is a flow diagram depicting a procedure in an exemplary implementation in which a two-dimensional barcode formed by the procedure of FIG. 2 is decoded.

FIG. 5 is a flow diagram depicting a procedure in an exemplary implementation in which a barcode is generated and colored to mimic an image.

FIG. 6 is a flow diagram depicting a procedure in an exemplary implementation in which a barcode is encoded using color to increase data density.

FIG. 7 is a flow diagram depicting a procedure in an exemplary implementation in which a colored barcode is decoded by a client.

FIG. 8 is a flow diagram depicting a procedure in an exemplary implementation in which binary data is encoded in a barcode along with an identifier of one or more modules that are executable to render the binary data by a client.

FIG. 9 is a flow diagram depicting a procedure in an exemplary implementation in which an executable module is encoded in and decoded from a barcode.

FIG. 10 is an illustration in an exemplary implementation showing an exemplary mapping scheme for a barcode having a plurality of layers.

FIG. 11 is an illustration in an exemplary implementation showing parent and child layers.

FIG. 12 is an illustration in an exemplary implementation showing application of the mapping scheme of FIG. 10 to provide legacy support in a colorful barcode having a plurality of layers.

FIG. 13 is an illustration in an exemplary implementation showing decoding of a legacy layer in the barcode of FIG. 12.

FIG. 14 is an illustration in an exemplary implementation showing decoding of a colorful layer in the barcode of FIG. 12.

### DETAILED DESCRIPTION

Overview

Barcodes may be configured in a variety of ways. A typical barcode, for instance, is configured as a row of bars having differing thicknesses that are readable along a single axis and therefore are also referred to as “one-dimensional” barcodes. One-dimensional barcodes, however, provided limited data due to the number of lines and spaces used by the barcode in representing the numbers.

Two-dimensional barcodes were developed to increase an amount of data that may be encoded by the barcode. One such example is commonly referred to as a Quick Response (QR) barcode. However, the two-dimensional barcode may consume a significant amount of space when included on a surface (e.g., a magazine) and therefore intrude on the “look and feel” of a product that includes the barcode. For instance, a traditional two-dimensional barcode may be represented using a multitude of black and white dots to encode data along with shapes and lines used to orient a reader/decoder of the barcode. This representation, however, may not be visually pleasing to the users and therefore may interfere with the users' experience with the product.

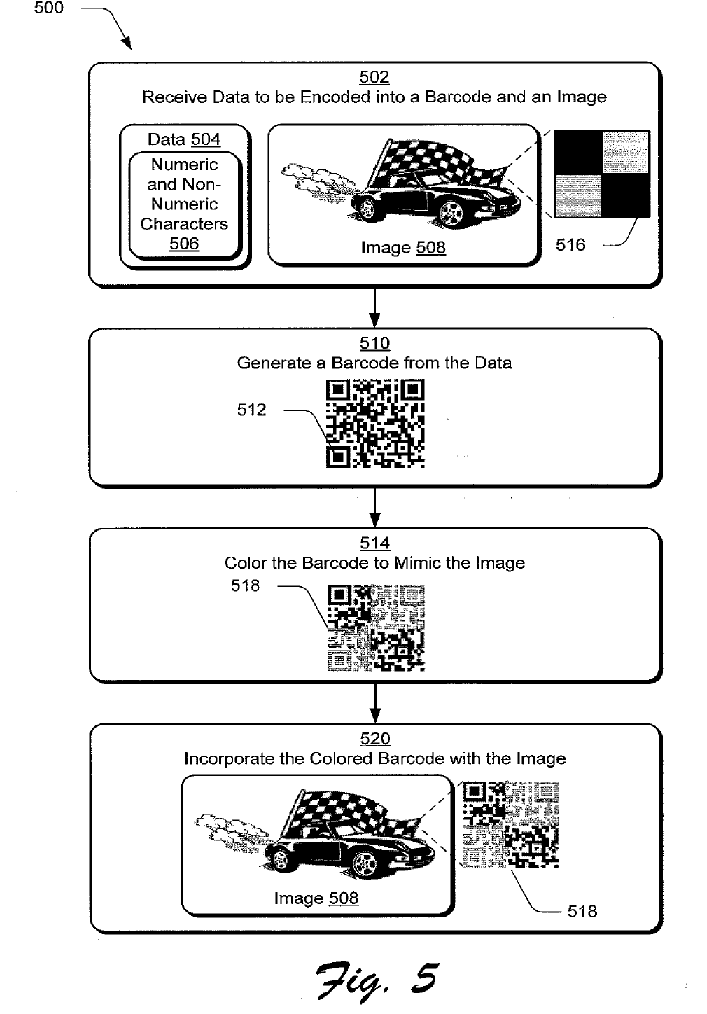

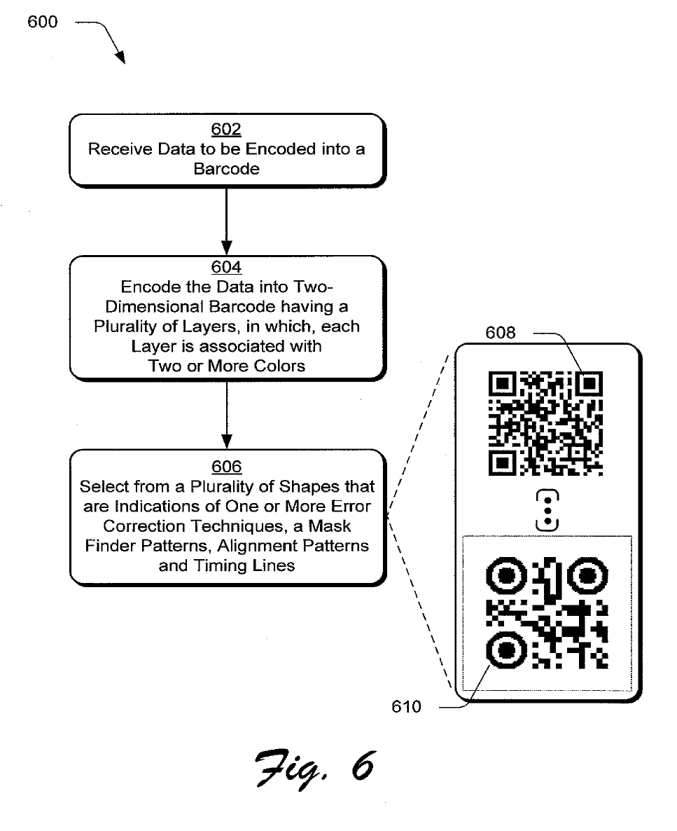

In an implementation, techniques are described which may be used to configure a barcode for incorporation on a product through the use of color. For example, a barcode may be generated with color applied to portions of the barcode in order to mimic an image, such as a company's logo, part of a photograph, and so on. Further, control elements used to align an image of the barcode for processing may also be configured based on a variety of considerations, such as to change the shape of the elements to be consistent with a desired image. In this way, the barcode may be associated with a product and not interfere with the users' interaction with the product, further discussion of which may be found in relation to FIGS. 5 and 6.

Color may also be used to increase an amount of data that may be incorporated by the barcode. For example, the barcode may be encoded using a plurality of layers, in which, each of the layers corresponds to two or more colors. The two or more colors may therefore be used to encode data. For example, four colors may be used for each dot, and therefore represent two bits. Therefore, the barcode having the multiple layers may be though of as a plurality of barcodes of different colors which are added together to form a composite barcode. Further discussion of layers may be found in relation to FIG. 6.

Additionally, traditional techniques that were used to encode and decode barcodes may be inefficient. Therefore, these techniques may result in a needless consumption of an area on a display surface that includes the barcode, such as through inclusion of redundant information as well as needless consumption of resources by devices used to encode and/or decode the barcode.

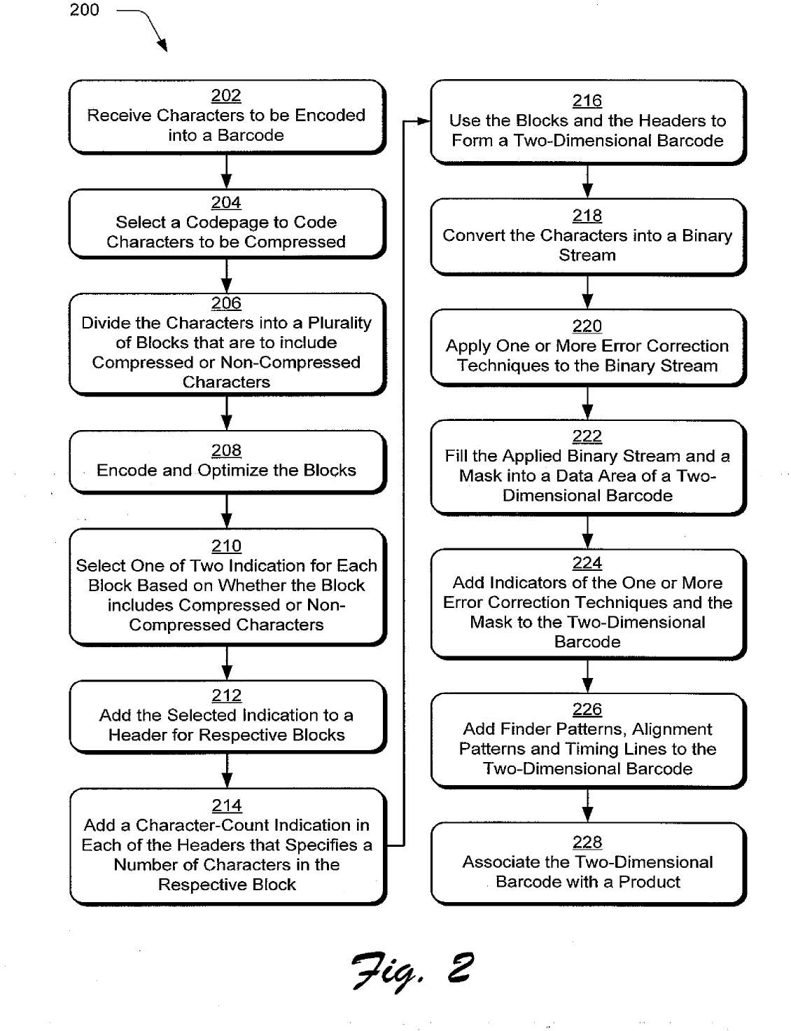

Accordingly, one or more techniques are described in which characters included in content that is to be used to form a barcode are grouped into consecutive blocks that are to have compressed or non-compressed characters. One of two indications categories then included in headers of the blocks which indicate the type of characters (e.g., compressed or non-compressed) included in the respective blocks. A codepage is used to encode the characters to be compressed (e.g., non-eight-bit characters) while the non-compressed characters are encoded as a binary representation (e.g., via eight-bits), such as a number that corresponds to the non-compressed characters. In an implementation, the encoded barcode includes a single indication of which codepage to encode the compressed blocks and is therefore not repeated in the headers of each of the compressed blocks, thereby removing redundant information and improving efficiency of the barcode. In another implementation, the indication is not provided, but rather a decoding client may obtain this information from other sources, such as to use a default codepage, use an independent parameter interface to obtain the codepage information, and so on. Further discussion of encoding and decoding of the barcode may be found in relation to FIGS. 2-4.

In the following discussion, an exemplary environment is first described that is operable to perform techniques to encode and/or decode barcodes. Exemplary procedures are then described that may be employed in the exemplary environment, as well as in other environments.

Exemplary Environment

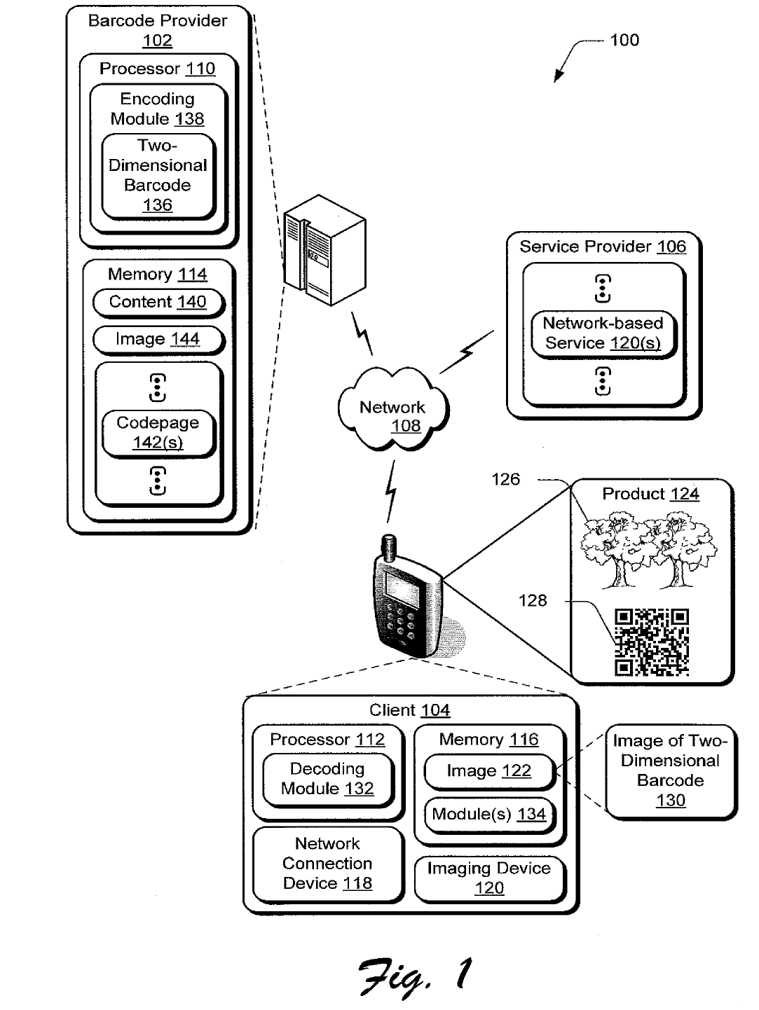

FIG. 1 is an illustration of an environment 100 in an exemplary implementation that is operable to employ barcode encoding and decoding techniques. The illustrated environment 100 includes a barcode provider 102, a client 104 and a service provider 106 that are communicatively coupled, one to another, via a network 108. In the following discussion, the barcode provider 102, the client 104(n) and the service provider 106 may be representative of one or more entities, and therefore reference may be made to a single entity (e.g., the client 104) or multiple entities (e.g., the clients 104, the plurality of clients 104, and so on).

The client 104 may be configured in a variety of ways. For example, the client 104 may be configured as a computing device, such as a desktop computer, a mobile station, an entertainment appliance, a set-top box communicatively coupled to a display device, a wireless phone as illustrated, a game console, and so forth. Thus, the client may range from full resource devices with substantial memory and processor resources (e.g., personal computers, game consoles) to low-resource devices with limited memory and/or processing resources (e.g., traditional set-top boxes, hand-held game consoles). The client 104, in portions of the following discussion, may also relate to a person and/or entity that operate the clients. In other words, the client 104 may describe a logical client that includes users, software, and/or devices.

The barcode provider 102 is illustrated in FIG. 1 as being implemented by a server and the client 104 is illustrated as a client device, each of which having respective processors 110, 112 and memory 114, 116. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 114, 116 is shown, respectively, for the barcode provider 102 and the client 104, a wide variety of types and combinations of memory may be employed, such as random access memory (RAM), hard disk memory, removable medium memory, and other types of computer-readable media.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be configured to include multiple networks.

The client 104 is also illustrated as including a network connection device 118 and an imaging device 120. The network connection device 118 is representative of a device that is configured to access the network 108, such as a wireless connection device (e.g., as used by a wireless phone), a wired connection device, and so on. The imaging device 120 is representative of a device configured to taken and store an image, such as a digital camera that incorporates a charge-coupled device (CCD), and so on.

The client, for instance, may use the imaging device 120 to store an image 122 of a viewable product 124, such as a sign, an advertisement, and so on. The product 124, for instance, may include content 126 to be viewed by a user, such as the illustration of trees in FIG. 1 and also a printed two-dimensional barcode 128. Therefore, the image 122 taken of the product 124 may also include an image of the two-dimensional barcode 130.

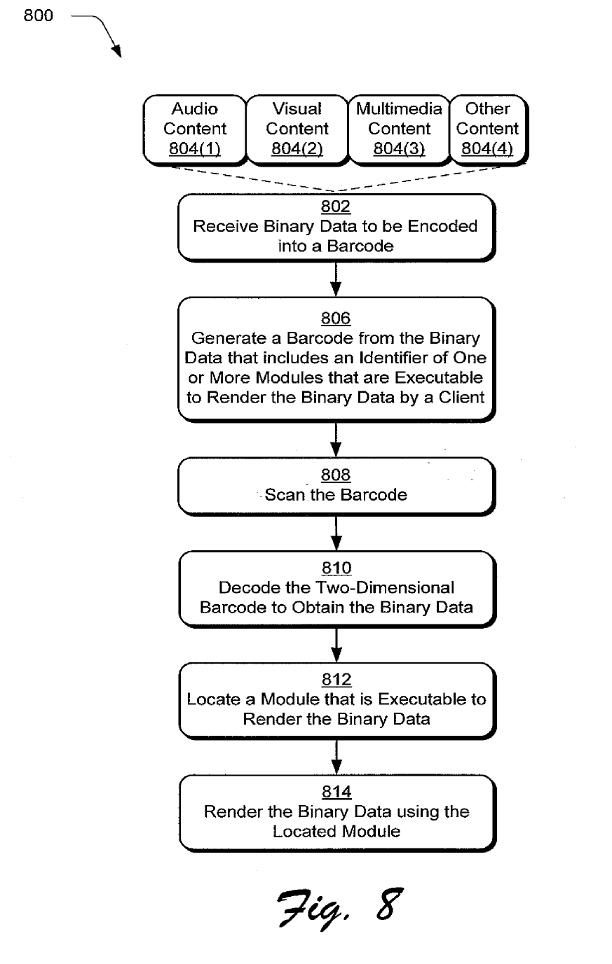

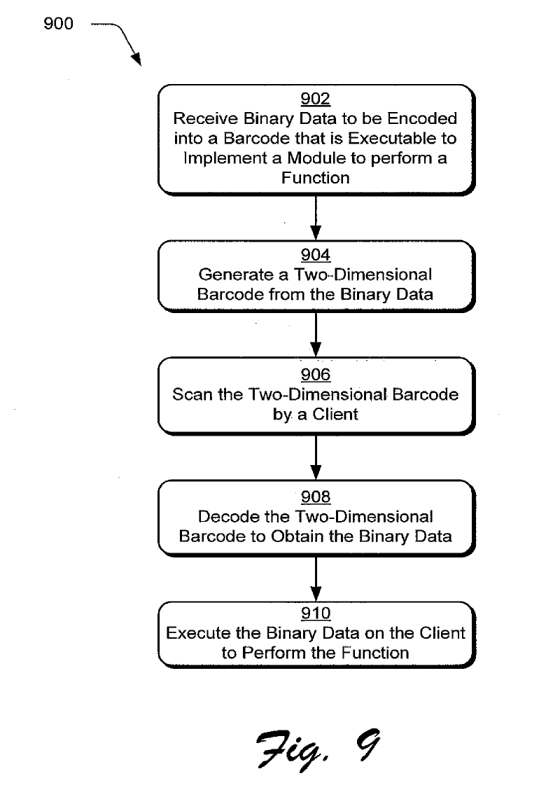

The image of the two-dimensional barcode 130 may then be decoded through use of a decoding module 132, which is illustrated as being executed on the processor 112 and is storable in memory 116. The decoding module 132, for instance, may employ a variety of techniques to decode the image in order to arrive at information encoded within the image, such as characters and/or binary data that is renderable by one or more module(s) 134. For example, one of modules 134 may be configured as a music player that is executable to play binary data representing music. A variety of other examples are also contemplated, such as through encoding of executable binary code, further discussion of which may be found in relation to FIGS. 8 and 9.

The two-dimensional barcode 128 in this example is printed from a two-dimensional barcode 136 generated by the barcode provider 102. The barcode provide 102, for instance, is illustrated as executing an encoding module 138 on the processor 110, which is also storable in memory 114. The encoding module 138 is representative of functionality that is executable to generate a barcode (in single or multiple dimensions) to encode data, such as characters and/or binary data. A variety of techniques may be employed by the encoding module 138 to encode data.

The encoding module 138, for example, may employ techniques to simplify how text included in content 140 is encoded. The techniques, for example, may divide consecutive blocks of characters to be compressed from consecutive blocks of characters in the content 140 that are not to be compressed. The compressed blocks may be encoded into a compressed mode (e.g., a non-eight-bit mode) and the non-compressed blocks may be encoded into an eight-bit mode (although other modes are contemplated) using one of the codepages 142(s) (where “s” can be any integer from one to “S”) which are illustrated as stored in memory 114.

In an implementation, each of the non-compressed blocks is encoded using the same codepage 142(s) and therefore an indication is not included in a header of each of the non-compressed blocks indicating which codepage 142(s) was used for the particular blocks. In this way, the encoding module 138 may efficiently encode the content 140 without use of redundant information. Further, a codepage that is different than the codepage used to encode the content 140 may be used to decode the content, thereby providing a more universal barcode, e.g., by enabling decoding using different yet compatible codepages such as ASCII a Greek codepage “A” is same as the “A” in Japan codepage. A variety of other instances are also contemplated, further discussion of which may be found in relation to FIGS. 2-4.

In another example, the encoding module 138 may use color to generate a barcode. For example, the encoding module may receive the content 140 and an image 144. The encoding module may then color the two-dimensional barcode 136 to mimic the use of color in the image 114. For instance, the barcode may be colored to give the appearance of a corporate logo, a portion of a picture for inclusion with the picture on a product 124, and so on. In this way, the two-dimensional barcode 136 does not intrude on the content but rather may be seen as an integral part of the content, further discussion of which may be found in relation to FIG. 5. As previously described, a variety of other coloring techniques are also contemplated, such as to color a two-dimensional barcode in layers to increase an amount of data included in the barcode, further discussion of which may be found in relation to FIG. 6.

Content 140 encoded by the barcode provider 102 to form the barcode (e.g., the two-dimensional barcode 136) is not limited to characters, but may also encompass a wide variety of other data. For instance, the content 140 may be configured as a textual uniform resource locator (URL) that references a network address of one or more network-based services 146(s) (where “s” can be any integer from one to “S”) that are available over the network 108 from a service provider 106. A user, for instance, may take a picture of the product 124 using the imaging device 120, decode the image of the two-dimensional barcode 130 within the image 122, and use the network connection device 118 to access the network-based service 120(s) specified by text configured as a URL in the barcode.

The two-dimensional barcode 136 may also encode a variety of other content, such as binary data that is executable on the processor as a module, audio content (e.g., music, ring tones, etc.), video content (e.g., images of movie posters), multimedia content (e.g., a movie trailer), and so on. Thus, the barcode may be used to provide content other than text directly from the barcode itself, further discussion of which may be found in relation to FIGS. 8-9.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer readable memory devices, e.g., memory 112(m), 114(n). The features of the techniques described below are platform-independent, meaning that the techniques may be implemented on a variety of commercial computing platforms having a variety of processors.

Exemplary Procedures

The following discussion describes barcode encoding and decoding techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1.

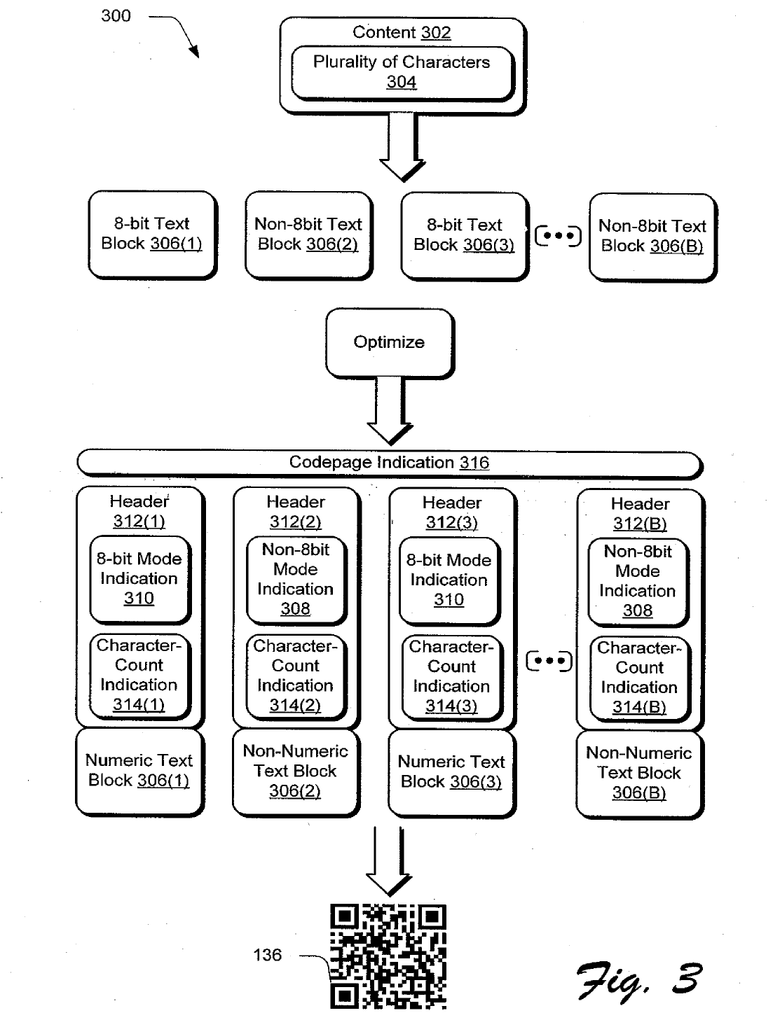

FIG. 2 depicts a procedure 200 in an exemplary implementation showing a simplified text encoding technique. During the discussion of FIG. 2, reference will also be made to illustration of FIG. 3 showing an exemplary implementation 300 of character encoding accordingly to the procedure 200 of FIG. 2. Characters are received to be encoded into a barcode (block 202). The barcode provider 102, for instance, may receive content 302 having a plurality of characters 304 from a variety of sources, such as an advertiser, publisher, and so on. The characters may be configured in a variety of ways, such as uniform resource locators (URLs), coupon codes, product identifiers, and so on.

A codepage is selected to code characters (block 204) in the content. For example, a technician of the barcode provider 102 may determine that the barcode is to be used in a particular market and select one of the codepages 142(s) that correspond to that market, such as a codepage describing characters used in a language in that market. In another example, the technician may select a “universal” codepage, such as a codepage configured in compliance with Unicode UTFS to provide universal use characters that may be decoded from the barcode. In such an example, this codepage can be used to replace the use of different codepages, thereby providing universal encoding and decoding in a variety of markets that employ a variety of different languages. A variety of other examples are also contemplated.

The characters are divided into a plurality of blocks that are to include compressed or non-compressed characters (block 206). The encoding module 138, for instance, may example each of the characters in the content 302 in order and divide the characters into consecutively ordered blocks 306(1)-306(B) that are to have compressed characters or non-compressed characters, but not both. In other words, compressable text followed by non-compressable text would be divided into a text block to be compressed followed by a text block that is not to be compressed.

The blocks may then be encoded and optimized (block 208). The blocks having characters to be compressed are encoded using the codepage, while blocks having characters that are not to be compressed are represented “directly” without the codepage. Further, whether compression or non-compression is used to encode the characters may be optimized. For example, in some instances it may be more efficient “follow” encoding used for prevision characters to save from the use of additional header information. For instance, each block may have header information that provides a mode indication and a character count indication. For a string “AQ9F”, for instance, if the “9” is encoded into a non-compressed (e.g., eight-bit mode), while some bits may be saved in encoding the “9” itself, the following character “F” will use a new header. Therefore, because this encoding does not “save” bits, in such an instance the nine may also be encoded to match the previous character. Thus, the encoding module 138 may perform a comparison as to which technique will result in greater overall compression for various strings of characters having varying lengths and choose accordingly (e.g., to use or not to use compression), thereby optimizing the encoding. A variety of other examples are also contemplated.

One of two indications is selected for each block based on whether the block includes compressed or non-compressed characters (block 210) and is added to the respective blocks (block 212). For example, a compressed indication (e.g., a non-eight-bit indication 308) may be configured to indicate that characters within the respective text block are compressed, e.g., non-8-bit mode text blocks 306(1), 306(3), and therefore are decoded using a code page.

The non-compressed indication (e.g., 8-bit mode indication 310), on the other hand, may indicate that characters within the respective text block are not compressed, which may be represented “directly” (e.g., with a codepage) using eight bits. Thus, the non-compressed indication (e.g., the 8-bit mode indication 310) may be configured as an “eight-bit indication” to reference that an eight-bit technique is used to represent characters within the block, whereas the characters within the compressed text block are not so represented. A variety of other non-eight-bit implementations are also contemplated to represent compressed text. Thus, in this example the indications do not reference a particular codepage that was used to encode the characters in the text block (i.e., the indications are generic as to the codepage used), but rather simply indicate a compressed or non-compressed nature of the characters. These indications 308, 310, when selected, are then added to respective headers 312(1)-312(B) of the blocks.

A character-count indication 314(1)-314(B) is also added to each of the headers 312(1)-312(B) that specifies a number of characters in the respective block (block 214). Also, a single indication of which codepage was selected to code the non-compressed text blocks may also added, which is illustrated as the codepage indication 316 in FIG. 3. Thus, the indication of the codepage is not repeated in each of the headers 312(1)-312(B), thereby increasing efficiency of the barcode to encode data, e.g., more data may be encoded in a corresponding area. Further, encoding and/or decoding may also be performed with increased efficiency by removal of a step for each of the headers to look-up a particular codepage. A variety of other instances are also contemplated.

The block and headers are then used to form a two-dimensional barcode (block 216). For example, the characters may be converted into a binary stream (block 218), including the characters in the headers. One or more error correction techniques may be applied to the binary stream (block 220), such as through inclusion of redundant bits and so on depending a level (i.e., amount) of error correction chosen for the binary stream. For example, data of increased importance may use error corrections techniques that are more robust whereas data that is not as important may use less robust techniques. The applied binary stream and a mask are then filled into a data area of a two-dimensional barcode (block 222). The mask, for instance, may be used to break different colored areas (e.g., black and white) to proportion “dots” of the barcode.

Indications of the one or more error correction techniques and the mask are added to the two-dimensional barcode (block 224). Additionally, finder patterns, alignment patterns and timing lines are also added (block 226) to enable a client that decodes the barcode to orient the barcode for decoding. The resultant barcode 136 generated by the barcode provider 102 may then be associated with a product, such as through inclusion on a printed product, included in a televised advertisement, a webpage, a sign for display in front of a business, and so on. The associated barcode may then be decoded by a client to use the information encoded therein, further discussion of which may be found in relation to the following figure.

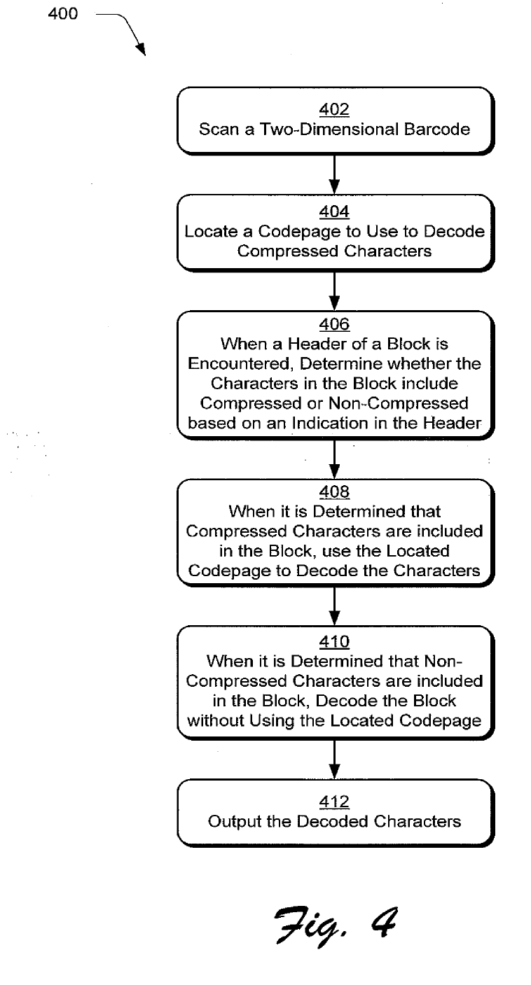

FIG. 4 depicts a procedure 400 in an exemplary implementation in which a two-dimensional barcode formed by the procedure 200 of FIG. 2 is decoded. A two-dimensional barcode is scanned (block 402). For example, a user may use a wireless phone to take a picture of an advertisement having a barcode in a magazine.

A codepage is located for use in decoding non-compressed text (block 404). The decoding module, for instance, may locate an indication generated for and included in the barcode that indicates which codepage was selected during the encoding process (e.g., blocks 204, 214) to encode the barcode. In another instance, the decoding module may locate a default codepage that is to be used to decode whatever barcode is encountered.

Blocks of data encoded into the barcode may then be examined in order for decoding. Headers which are included in the blocks, for instance, may then be used to determine how to decode the blocks. For example, when a header of a block is encountered, a determination is made as to whether the characters in the block include compressed of non-compressed characters based on an indication in the header (block 406). As previously described, for instance, the indication may be configured as an “eight-bit” indication or a “non-eight-bit” indication.

When it is determined that compressed characters are included in the block, the located codepage is used to decode the characters (block 408). Thus, in this instance the indication (e.g., the non-eight-bit indicator) indicates that a codepage is to be used to decode the block, but does not indicate which particular codepage is to be used. The indication of which codepage to use is provided through a single indication (e.g., the codepage indication 316 of FIG. 3) or even not at all (e.g., use of default codepages as previously described), and thus need not be repeated for each of the blocks, thereby conserving resources, such as available area to encode information and removal of needless repetition of steps during the decoding process as previously described.

When it is determined that non-compressed characters are included in the block, the block is decoded without using the located codepage (block 410). For example, binary data included in that block may be read directly without a codepage to generate a number representing the numerical characters encoded from the content in that block. Additionally, because a codepage is not used the represented numbers may be decoded without that additional step and the number may be represented using fewer bits, thereby improving efficiency. The decoded characters are then output (block 412), such as for rendering by one or more of the module(s) 134. A variety of other examples are also contemplated.

FIG. 5 depicts a procedure 500 in an exemplary implementation in which a barcode is generated and colored to mimic an image. Data to be encoded into a barcode and an image are received (block 502). For example, the data 504 may include compressed and non-compressed characters 506 that are provided by an advertiser to be incorporated into an advertisement, such as details of an automobile depicted in an image 508 in the advertisement.

A barcode is generated from the data (block 510). For example, the barcode 512 may be configured as a two-dimensional barcode generated using the techniques as previously described in relation to FIGS. 2-3, generated using other two-dimensional barcode generation techniques, generated as a one-dimensional barcode, and so on.

The barcode is also colored to mimic the image (block 514). For example, the barcode may be configured for incorporation in a certain portion 516 of the image 508 and therefore have portions of the barcode 518 colored to mimic corresponding portions 516 in the image 508, such as through coloration to mimic a part of a checkered flag as illustrated in FIG. 5. The colored barcode 518 may then be incorporated with the image 508 (block 520) and in this way, not interfere with an overall impression imparted to a viewer of the image 508. A variety of other examples are also contemplated, such as through mimicking of a corporate logo, “buzz” phrase, and so on. Although coloration of a barcode to mimic an image has been described, coloration may be used to provide a wide variety of other functionality, further discussion of which may be found in relation to the following figure.

FIG. 6 depicts a procedure 600 in an exemplary implementation in which a barcode is encoded in a plurality of layers using a plurality of colors. Data is received to be encoded into a barcode (block 602). For example, the data may be encoded using traditional barcode generation techniques, encoded using the techniques previously described, and so on.

The data is then encoded into a two-dimensional barcode having a plurality of layers, in which, each layer is associated with two or more colors (block 604). For example, two colors may be chosen for each layer of the barcode, such as red/blue, green/black, and so on. The data received may then be encoded into these layers in a variety of ways, such as to mimic an image as previously described in relation to the previous figure. Through use of multiple colors, the barcode may be configured for incorporation with a wider range of images. Further, the amount of data encoded in a corresponding area may be increased by increasing the “density” of information encoded by each “dot” in the barcode. For example, when each “dot” of the image may use four color options, then the dot can represent 2 bits, 1024 colors may represent 10 bits, and so on.

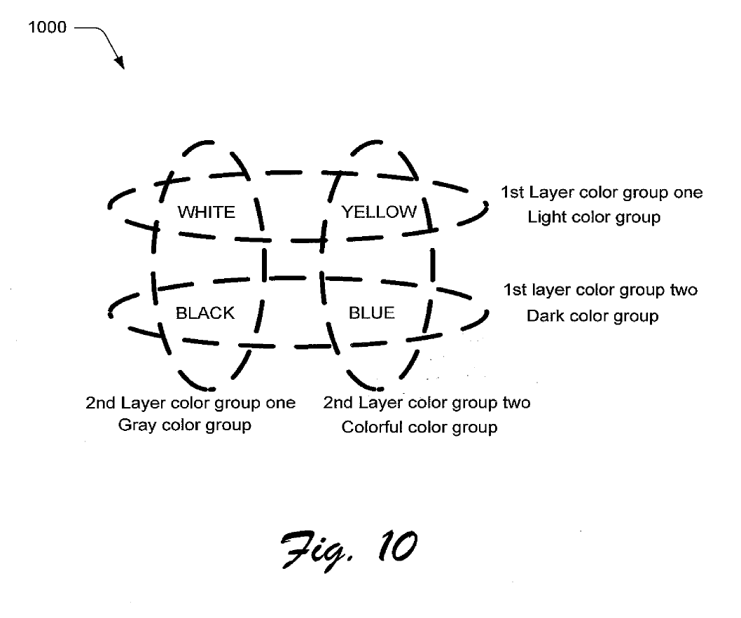

In another example, the two-dimensional barcode may be encoded to be compatible with “legacy” barcodes, such as a legacy Quick Response (QR) code. For instance, a first one of the layers may be encoded using black and white to be readable by a legacy decoder, with a second layer using other colors that are compatible with decoders that incorporate these “colorful” techniques. Naturally, a variety of other examples are also contemplated, further discussion of which may be found in relation to FIGS. 10-12.

A variety of additional techniques may also be used to configure the barcode to mimic an image. For example, the barcode provider may select from a plurality of shapes that are indications of one or more error correction techniques, a mask finder pattern, alignment patterns and timing lines. The barcode provider 102, for instance, may include a database of different shapes which may be used of each of the indications, such as a square finder pattern 608 or a round finder pattern 610 as illustrated in FIG. 6. For instance, a “round” finder pattern may be selected for use with each of the layers. In this way, the barcode provider may configure indications included in the barcode itself to mimic an image thereby further improving the “look-and-feel” the barcode when incorporated on a product.

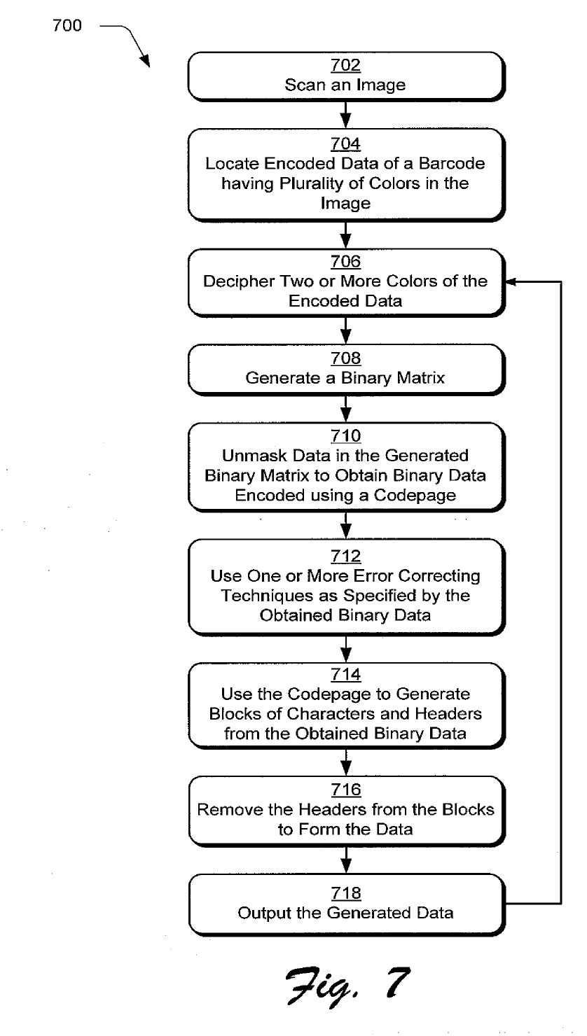

FIG. 7 depicts a procedure 700 in an exemplary implementation in which a colored barcode is decoded by a client. An image is scanned (block 702). For example, a client may scan the image using an included imaging device 120, such as through use of a camera of a wireless phone.

Encoded data is located in the image of a barcode, the barcode having a plurality of colors (block 704). Two or more colors of the encoded data are then deciphered (block 706). For example, the barcode may be made up of “layers” which are defined by two colors in a technique similar to how a black and white barcode is encoded. Threshold may be defined for each of the colors (e.g., color, intensity, hue, etc.) such that the colors representing data may be distinguished from “background”, i.e., non-data encoding colors that are part of the image, further discussion of which may be found in relation to FIGS. 10-14.

Once the encoded data is identified, the data may then be decoded. For example, a binary matrix may be generated from the barcode (block 708). The data in the generated binary matrix is then unmasked to obtain binary data encoded using a codepage (block 710). One or more error correcting techniques may then be used as specified by the obtained binary data (block 712), such as to collect imaging or translation errors. The codepage may then be used to generate blocks of characters and headers from the obtained binary data (block 714), such as by employing techniques as previously described in relation to FIG. 4. The headers are then removed from the blocks to form the data (block 716), which may then be output (block 718) for a variety of purposes. Although the previous discussion described the encoding and decoding of characters, a wide variety of binary data may also be encoded and decoded through the use of barcodes, further discussion of which may be found in relation to the following figures.

FIG. 8 depicts a procedure 800 in an exemplary implementation in which binary data is encoded in a barcode along with an identifier of one or more modules that are executable to render the binary data by a client. Binary data to be encoded into a barcode is received (block 802). The binary data may be configured in a variety of ways, such as audio content (e.g., a ring tone, music file, ring back tone, and so on), visual content (e.g., advertisement, static image, video image, and so on), multimedia content 804(3) (e.g., a movie trailer), and/or other content 804(4).

A barcode is generated from the binary data that includes an identifier of one or more modules that are executable to render the binary data by a client (block 806). For example, the identifier may be configured to indicate a type and/or a protocol used to encode the data (e.g., Graphic Interchange Format), an identifier particular to the module itself (e.g., MICROSOFT WORD, MICROSOFT and WORD are trademarks of the Microsoft Corp., Redmond Wash.), and so on. The barcode, having the identifier, may then be incorporated on a surface, such as a surface of a product, in an advertisement, and so on.

Upon receipt by a client, the two-dimensional barcode is decoded to obtain the binary data (block 810), such as through use of one or more techniques as previously described and/or other techniques. A module is located that is executable to render the binary data (block 812), such as a media-rendering module, a photo viewer, and so on, and the binary data is rendered using the located module (block 814). Thus, in this example the binary data itself is rendered by a module and thus may expand functionality of traditional techniques that were used to encode characters, solely. For example, rather than encode a URL in a barcode to a network address, from which, the client may obtain a ring tone, the ring tone itself may be encoded directly within the barcode. A variety of other examples are also contemplated, such as through encoding of an executable module itself in the barcode, further discussion of which may be found in relation to the following figure.

FIG. 9 depicts a procedure 900 in an exemplary implementation in which an executable module is encoded in and decoded from a barcode. Binary data is received to be encoded into a barcode that is executable to implement a module to perform a function (block 902). For example, the module may be executable by itself to perform a function (i.e., a stand-alone module) or may be executable to contribute functionality to another module, e.g., a “plug-in” module. A variety of other examples are also contemplated.

A two-dimensional barcode is generated for the binary data (block 904), which may later be scanned and decoded by a client (blocks 906, 908) as previously described. The binary data is then executed on the client to perform the function (block 910). The binary data, for instance, may be directly executable by the client without converting the data to characters, e.g., the binary data may already be in a compiled form. A variety of other instances are also contemplated without departing from the spirit and scope thereof.

Colorful Techniques

As previously described, “colorful” techniques may be employed to increase data density as well as provide compatibility with traditional barcode decoders. For example, traditional barcode decoders decoded the barcodes with black and white modules by distinguishing darker modules from lighter ones, e.g., by recognizing “darker dots” as black and “lighter dots” as white.

In an implementation, to provide “legacy” support the colorful barcode may include a plurality of layers, in which the first layer follows the “dark-and-light” technique. For example, each layer of the barcode may contain some information, with the information in the first layer is called the “parent” information. The other information contained in the remaining layers may be called “child” information. With predefined color mapping scheme, colorful barcode can be encoded. Traditional decoders can decode the parent information in the first layer. Additionally, decoders following the “colorful” techniques may decode both parent and child information. Therefore, this technique may increase the amount of data that may be encoded in the barcode while maintaining the compatibility of this colorful barcode to traditional decoders.

For example, as shown in FIG. 10, a color mapping scheme may be employed having two layers. The first layer of the barcode is distinguishable from the other layers by a “dark versus light” technique. Colors in the second layer may then be distinguished from the first layer, and indeed other layers, by self-defined techniques. For instance, the self-defined technique used by the second layer in the illustrated example distinguishes gray colors from colorful colors. It should be apparent that a variety of other techniques may also be employed.

Continuing with the previous example, the following mapping scheme may be employed according to the techniques described above:

| | | |
|---|---|---|
| 0 | 0 | White |
| 0 | 1 | Yellow |
| 1 | 0 | Black |
| 1 | 1 | Blue |

The first bit is utilized to distinguish dark colors from light colors, which follows the first layer technique. The second bit is utilized to distinguish gray colors from colorful colors, which follows the second layer technique.

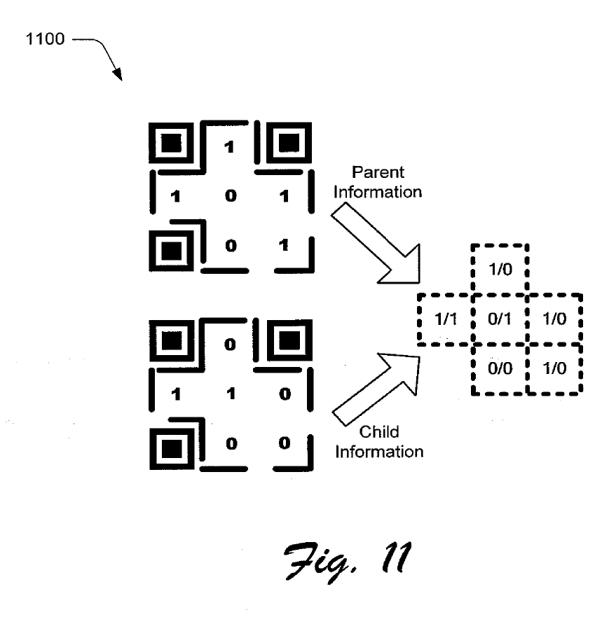

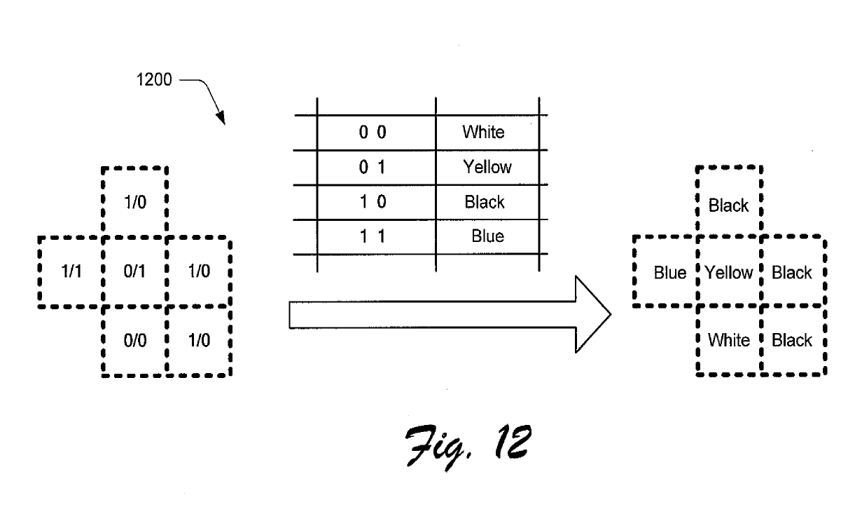

FIG. 11 depicts an implementation 1100 in which parent and child information is encoded into respective layers to form a colorful two-dimensional barcode. Two “black-and-white” barcodes are created. For illustration simplicity, the data in the barcodes is simplified to a few bits. A colorful barcode may then be created using the mapping scheme previously described, an example 1200 of which is shown in FIG. 12.

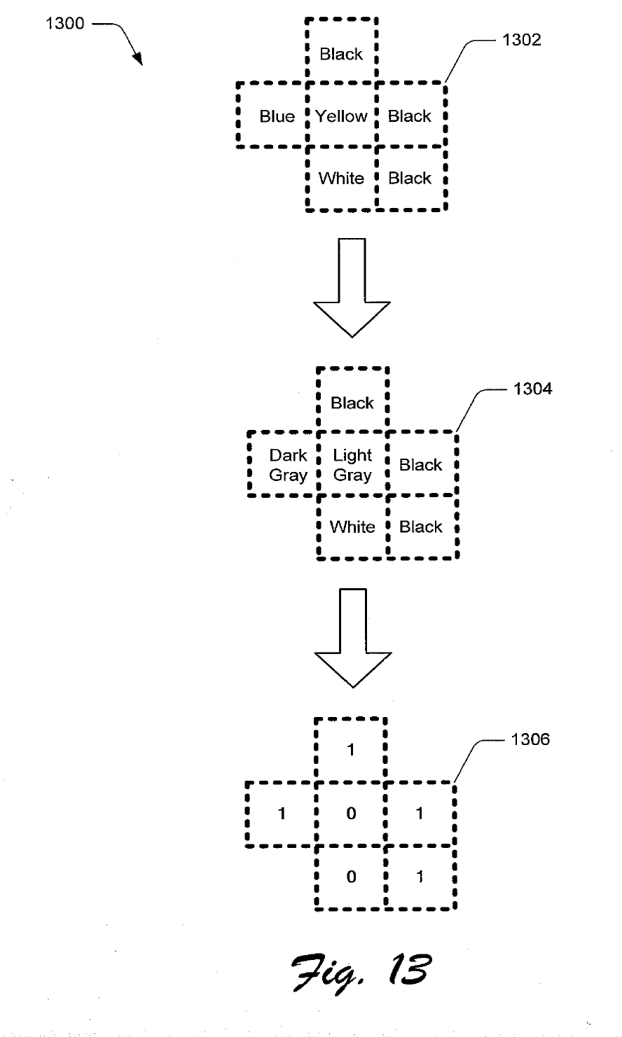

The “colorful” may then be decoded layer by layer. For example, FIG. 13 depicts an exemplary implementation 1300 in which a first layer of the colorful barcode of FIG. 12 is decoded. The “colorful” barcode 1302 is polarized to obtain a grayscale barcode 1304. Thresholds may then be applied to the grayscale barcode 1304 to obtain a “black and white” barcode, which may be processed as before to obtain the encoded data 1306.

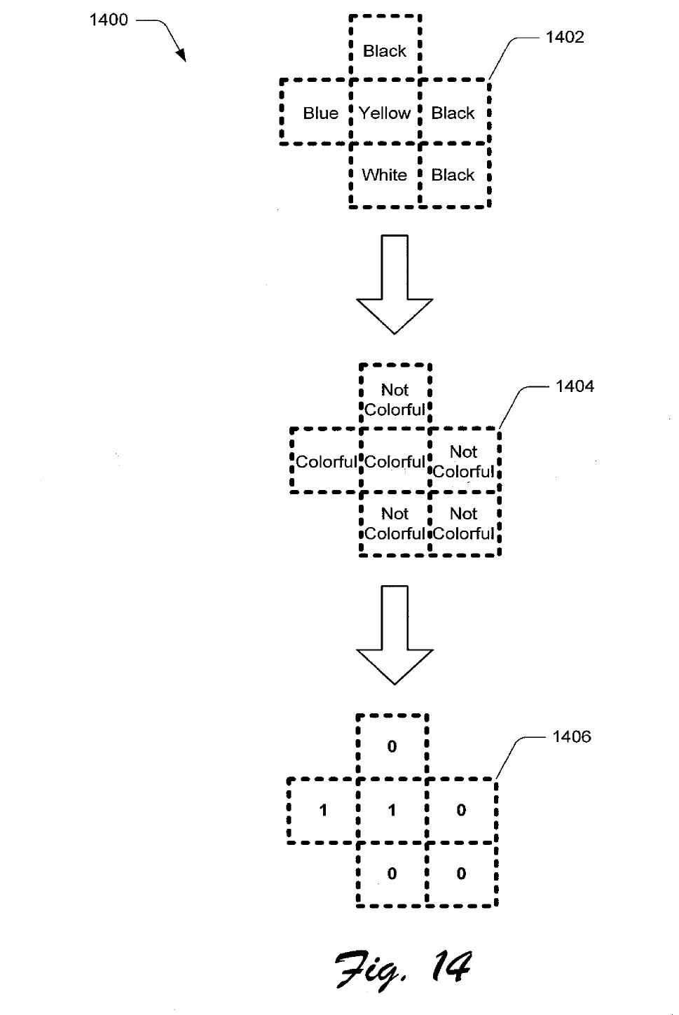

FIG. 14 depicts an exemplary implementation 1400 in which a second layer of the colorful barcode of FIG. 12 is decoded. The “colorful” barcode 1402 is separated based on the “gray versus colorful” technique previously described 1404, which may then be used to obtain binary representations 1406. Thus, the second layer may be a “child” layer to the “parent” layer of FIG. 13. Thus, the colorful barcode may provide support for legacy devices yet still provide expanded functionality to device that are configured to employ “colorful” techniques.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
dividing characters included in content into a plurality of blocks, wherein each said block is to include characters to be compressed or characters that are not to be compressed;
adding an indication in a header for each said block that specifies whether a respective said block includes compressed or non-compressed characters, wherein the indication of the non-compressed characters does not reference a particular codepage; and
encoding blocks that include non-compressed characters with the particular codepage.

2. A method as described in claim 1, wherein the particular codepage is used to encode each said block of non-compressed characters in the content.

3. A method as described in claim 1, wherein a single codepage indication:
is included in the encoded content; and
references the particular codepage that was used to encode the compressed characters.

4. A method as described in claim 1, wherein the indication that the respective said block includes non-compressed characters does not differentiate the particular codepage used to encode the non-compressed characters from another codepage that is also usable to encode non-compressed characters.

5. A method as described in claim 1, wherein one or more said headers added to respective said blocks having non-compressed characters include the indication of non-compressed characters and a character count indication but do not include an indication of the particular codepage used to encode the non-compressed characters.

6. A method as described in claim 1, further comprising encoding at least one block that includes non-compressed characters without using a codepage.

7. A method as described in claim 1, further comprising encoding at least one block that includes—compressed characters as a binary representation of a number corresponding to the compressed characters in the at least one block.

8. A method comprising:
generating a two-dimensional barcode; and
coloring the two-dimensional barcode to mimic an image.

9. A method as described in claim 8, wherein the barcode is two dimensional such that data is encoded in at least two axis.

10. A method as described in claim 8, wherein data included in the two-dimensional barcode encodes binary data that is non-textual.

11. A method as described in claim 8, wherein:
the generating includes selecting from a plurality of shapes to be included in the barcode; and
each said shape is configured to assist in a particular function that involves reading of the encoded data from the two-dimensional barcode.

12. A method as described in claim 11, wherein the functions are selected from the group consisting of:
error correction technique indication;
mask;
finder pattern;
alignment pattern; and
timing line.

13. A method as described in claim 8, wherein the coloring is performed such that portions of the two-dimensional barcode that correspond to portions of the image have corresponding colors.

14. A method as described in claim 8, wherein:
the coloring is performed such that two-dimensional barcode includes a plurality of layers; and
each said layer is defined by two or more colors used to encode data.

15. A method as described in claim 14, wherein data encoded in a first said layer does not match data encoded in a second said layer.

16. A method as described in claim 8, wherein:
the two-dimensional barcode is a Quick Response (QR) matrix barcode; and
the coloring is performed such that each dot of the two-dimensional barcode is chosen from at least three colors.

17. A method as described in claim 8, wherein the coloring includes use of at least three colors that mimic the image.

18. A method comprising:
receiving information; and
generating a two-dimensional barcode to encode the information using a plurality of layers, in which, each said layer is defined by two or more colors.

19. A method as described in claim 18, wherein:
the two-dimensional barcode is a Quick Response (QR) matrix barcode; and
the generating is performed such that each dot of the two-dimensional barcode is chosen from at least three colors.

20. A method as described in claim 18, wherein:
a first said layer is defined by two or more said colors that include black and white; and
a second said layer is defined by two or more other said colors that are not used to define the first said layer.

21. A method as described in claim 18, wherein at least one said layer of the two-dimensional barcode is configured to be compatible with a Quick Response (QR) matrix barcode.

22. One or more computer-readable media comprising executable instruction that, when executed, direct a client to locate a module based on an identifier found in a scanned image of a barcode, wherein the module is executable to render binary data encoded in the barcode.

23. One or more computer-readable media as described in claim 22, wherein the binary data is configured as content selected from a group consisting of:
audio content;
video content; and
multimedia content

24. One or more computer-readable media as described in claim 22, wherein the barcode is a two-dimensional barcode such that data is encoded in at least two axes in the barcode.
